(19) United States
(12) Patent Application Publication
(10) Pub. No.: US 2016/0023662 A1
(43) Pub. Date: Jan. 28, 2016

(54) Method and device for ascertaining a fatigue degree of a driver of a vehicle, and vehicle

(71) Applicant: Robert Bosch GmbH, Stuttgart (DE)

(72) Inventor: Felix Wulf, Ludwigsburg (DE)

(21) Appl. No.: 14/803,694

(22) Filed: Jul. 20, 2015

(30) Foreign Application Priority Data
Jul. 22, 2014 (DE) 10 2014 214 214.8

(51) Int. Cl. B60W 40/08

(52) U.S. Cl. CPC B60W 40/08; B60W 2040/0827

(57) ABSTRACT

A method and a device for ascertaining a fatigue degree of a driver of a vehicle, and to a vehicle, includes a driver-specific ascertainment of a change in the fatigue degree, and ascertaining the fatigue degree based on a previous fatigue degree, which is ascertained utilizing a driver-related circadian rhythm and the ascertained change in the fatigue degree. The method includes the ascertainment of the previous fatigue degree based on data about the driver in a time period during which the driver is not driving the vehicle.

RELATED APPLICATION INFORMATION

The present application claims priority to and the benefit of German patent application no. 10 2014 214 214.8, which was filed in Germany on Jul. 22, 2014, the disclosure of which is incorporated herein by reference.

### FIELD OF THE INVENTION

The present invention relates to a method and a device for ascertaining a fatigue degree of a driver of a vehicle, and to a vehicle.

### BACKGROUND INFORMATION

Methods and devices for determining a fatigue degree of an individual driver are being employed to an increasing extent in order to improve the road safety of vehicles operated by a driver. A fatigue degree that exceeds a certain fatigue threshold is referred to as drowsiness. When drowsiness is detected, an optical and/or acoustic signal can be output as a first step in order to briefly induce the driver to pay more attention and, in the long term, to schedule a rest stop. It is also possible that automatic control systems take over the vehicle operation. A reciprocally synonymous designation system is based on the term ‘attention’ and/or the term ‘alertness’.

Methods and devices for ascertaining the fatigue degree are also known as driver assistance systems or are part of driver assistance systems. The ascertaining of the fatigue degree in order to enhance safety is possible in different vehicles. A non-exhaustive list of examples of vehicles includes trucks and automobiles in road traffic, freight trains and passenger trains in rail traffic, as well as airplanes in air transportation.

Driver-operated vehicles basically include devices (control elements) that allow the driver to vary a speed of the vehicle. Such devices make it possible to vary the absolute amount of the speed, for instance via an accelerator pedal or a throttle lever and/or a brake pedal, and/or to modify the direction or rate of the directional change of the speed, for example via a steering wheel. The former may take the form of an acceleration, by stepping on the accelerator, or a deceleration, e.g., by taking the foot off the accelerator or releasing the gas pedal and/or braking. The latter may be accomplished by steering, for example. Figuratively speaking, the terms accelerator, stepping on the accelerator and taking the foot off the accelerator are also used for vehicles such as electrically operated vehicles, which, strictly speaking, are not really accelerated or decelerated via a gas supply.

One option for ascertaining the driver's degree of fatigue is to compare earlier with current changes in the vehicle speed induced by the driver.

For if there is an increase in the fatigue degree, corrections of intentional but unadapted driving behaviors are required more often, so that the intentionally induced speed variations become more pronounced. A still further increase in the fatigue degree may lead to micro-sleep events, which result in random speed variations of an unintentional nature. One objective of the method for ascertaining the fatigue extent is to warn against the occurrence of micro-sleep events in a timely manner.

The comparison of earlier with current speed variations of the vehicle that were triggered by the driver therefore makes it possible to determine a change in the fatigue extent.

If a previous fatigue degree is known, then the change in the fatigue degree may be used to update the fatigue degree.

Such a method requires an initialization of the fatigue degree. It has become apparent that it is advantageous, both for the initialization and for ascertaining the change in the fatigue degree, to parameterize the method according to the individual driver. The ascertainment of the change in the driver's fatigue degree adapts itself to the driver in an initial adaptation phase.

JP 2008035964A describes a device for rendering a decision about the drowsiness of a subject, the device including a memory unit in which decisions pertaining to the drowsiness of the subject in the past have been stored. The decisions from the past are utilized for a decision about the current drowsiness.

Known from U.S. Pat. No. 6,313,749 B is a drowsiness detection for generating an (audio) visual drowsiness display, which considers circadian and sleep parameters of the individual driver and/or generic or universal factors known from human psychology and integrates them with real-time behavior measurements of control actions by the driver including steering and acceleration.

WO 12144948A relates to a tachograph and a driver card that includes data relating to the driving and resting times of the driver. An alertness modeling unit calculates a current fatigue value for the driver with the aid of an alertness model. The model is based on three components: the degree of alertness, the circadian rhythm and the ultradian rhythm based on diurnal biological activity.

Biometric methods in principle allow the technical detection of drivers' faces.

### DISCLOSURE OF THE INVENTION

The inventors have recognized that the quality of the fatigue degree detection can be improved further.

The present invention provides a method for ascertaining a fatigue degree of a driver of a vehicle as recited in claim 1, a device for ascertaining a fatigue degree of a driver of a vehicle as recited in claim 7, and a vehicle as recited in claim 10.

The introduced method includes a step of a driver-specific ascertainment of a change in the fatigue degree and a step of ascertaining the fatigue degree on the basis of a previous fatigue degree that is ascertained with the aid of a driver-related circadian rhythm and which includes the ascertained change in the fatigue degree.

The introduced method is characterized by an ascertainment of the earlier fatigue degree on the basis of data of the driver from a period during which the driver is not driving the vehicle.

This is so because the use of data about the driver from a period during which the driver is not driving the vehicle makes it possible to improve the parameterization of the method for the initialization and/or for the ascertainment of the change in the fatigue degree, or to accelerate the parameterization, so that the fatigue degree is able to be determined more precisely in the short and/or the long term.

In one advantageous development, the period lies in the past, the driver having driven or the driver driving the vehicle immediately prior to or after said period of time. The data may then include a length of the time period, the length being compared to a limit value; if the duration of the previous fatigue degree lies below the limit value, using a further fatigue degree, which was determined on the basis of a speed change behavior immediately prior to the start of the time period, is ascertained.

This means that there is no need for a method reset after short breaks (pauses) in the driving, since it may be assumed that the fatigue degree of the driver has not changed significantly during the break.

On the other hand, if the duration exceeds the limit value, the previous fatigue degree can be ascertained with the aid of the driver-specific circadian rhythm.

The circadian rhythm provides an excellent initial estimate value of the fatigue degree of a driver.

The data may also include the activity information, stored in a mobile memory device, about an activity or multiple activities of the driver within the time period. The method may then furthermore include: Reading out the activity information from the memory device, and adapting the driver-specific circadian rhythm based on the activity information.

Electronic appointment calendars, for instance the calendars stored on smartphones, offer clues about fatiguing, attention-demanding activities or activities of the driver that in some other manner affect the circadian rhythm prior to and/or following the driving.

The read-out of the data may also take place in a wireless or cable-bound manner.

For example, the driver may currently drive the vehicle in a particular time zone and the activity information can include time zone information about at least one stay of the driver in another, different time zone.

This makes it possible to adapt the circadian rhythm to a possibly existing jet lag.

The activity information may also contain a history of recurring commuting routes of the driver. The history may then be used to ascertain a daily rhythm of the driver for adapting the circadian rhythm.

For example, commuting routes regularly covered by the driver may be taken into account in this manner even if the driver does not use a vehicle for these routes or if the driver uses another vehicle for this purpose.

The introduced device according to the present invention for ascertaining a fatigue degree of a driver of a vehicle includes a memory unit and an ascertainment unit; stored in the memory unit is a set of instructions that the ascertainment unit may execute, the method introduced according to the present invention being executed when the ascertainment unit executes the set of instructions. The vehicle introduced according to the present invention includes the inventive device.

In one advantageous specific development, the device additionally includes a camera for optically recording the face of the driver. The executable set of instructions stored in the memory unit is then configured in such a way that upon execution of the set of instructions by the ascertainment unit, a detection of driver-specific facial features and an identification of the driver based on additional driver-specific facial features that are stored in the memory unit takes place by comparing the detected facial features with the stored facial features.

This makes the use of driver cards unnecessary.

The stored facial features may be linked to driver-specific application parameters for a driver-specific initialization for the purpose of ascertaining a fatigue degree.

For example, the change in the fatigue degree may be determined on the basis of earlier changes in the vehicle speed and changes in the vehicle speed currently triggered by the driver.

Changes in the absolute amount of the speed, changes in the direction of the speed, and changes in the rate of the speed change and speed direction are considered speed variations in the context of this invention.

It is also possible to use an exterior camera or an interior camera for the fatigue degree change. In particular a blinking frequency of the driver and/or a maximum eye opening of the driver may be recorded with the aid of the interior camera and employed for the fatigue degree change. The blinking frequency of and/or a maximum eye opening can be used on their own or in combination with lane data from the exterior camera and/or speed changes of the vehicle.

Advantageous further developments of the present invention are delineated in the dependent claims and described in the specification.

Exemplary embodiments of the present invention are explained in greater detail with reference to the drawing and the following description.

### BRIEF DESCRIPTION OF THE DRAWINGS

FIG. 1 shows schematically an exemplary specific embodiment of the device according to the present invention.

FIG. 2 shows a flow chart of an exemplary embodiment of the method according to the present invention.

FIG. 3 shows schematically an exemplary specific embodiment of the vehicle according to the present invention.

### DETAILED DESCRIPTION

FIG. 1 schematically illustrates an exemplary specific embodiment of device 10 according to the present invention. A memory unit 100, which is configured in the form of a flash memory in the exemplary embodiment, is linked to an ascertainment unit 200, which is realized as a microprocessor in the exemplary embodiment. Ascertainment unit 200 may read out a set of instructions from memory unit 100, for instance in the form of a software program in the exemplary embodiment, and then execute it. The execution of the set of instructions by ascertainment unit 200 triggers the execution of the method of the present invention.

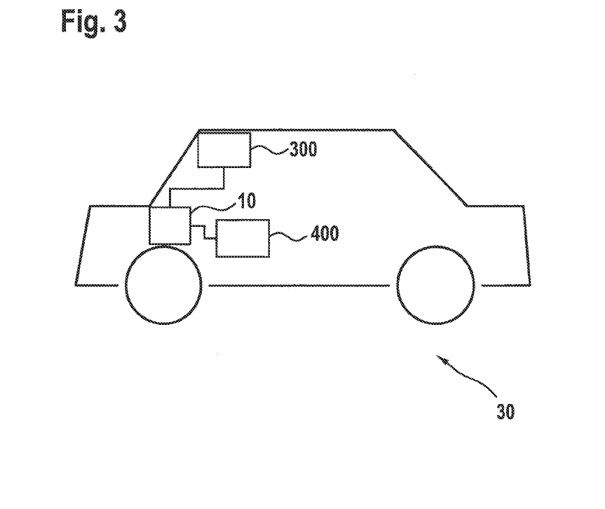

Device 10 is connected to a control unit 400 for this purpose, with whose aid a driver is able to vary the speed of a vehicle 30 shown in FIG. 3 by way of example. In the exemplary embodiment, device 10 is located inside vehicle 30. Control unit 400 of the exemplary embodiment includes an accelerator and a steering wheel. In particular, ascertainment unit 200 is connected to control unit 400, in such a way that current changes in the speed of vehicle 30 induced by the driver, i.e., interactions between the driver and the steering wheel and/or the accelerator, are able to be detected by ascertainment unit 200. In addition, earlier changes in the speed of vehicle 30 induced by the driver with the aid of control unit 400 are stored in memory unit 100. The earlier changes in speed are stored in a manner that links them to facial features of the driver. In addition, driver-specific application parameters, linked to the facial features of the driver, are stored for the parameterization of the method.

In the exemplary embodiment, device 10 is connected to a camera 300, which is likewise located inside vehicle 30. In particular, ascertainment unit 200 is connected to camera 300, so that the face of the current driver is recordable and facial features are able to be extracted from the recorded face. A comparison of the currently extracted facial features with the stored facial features makes it possible to select the earlier speed changes associated with the driver and/or the application parameters from the memory unit and to use them for initializing or parameterizing the method.

Instead of the camera, other driver identification arrangements may be used as well. In the least complicated case, vehicle 30 is meant to be used by a single driver only, so that an identification may be unnecessary.

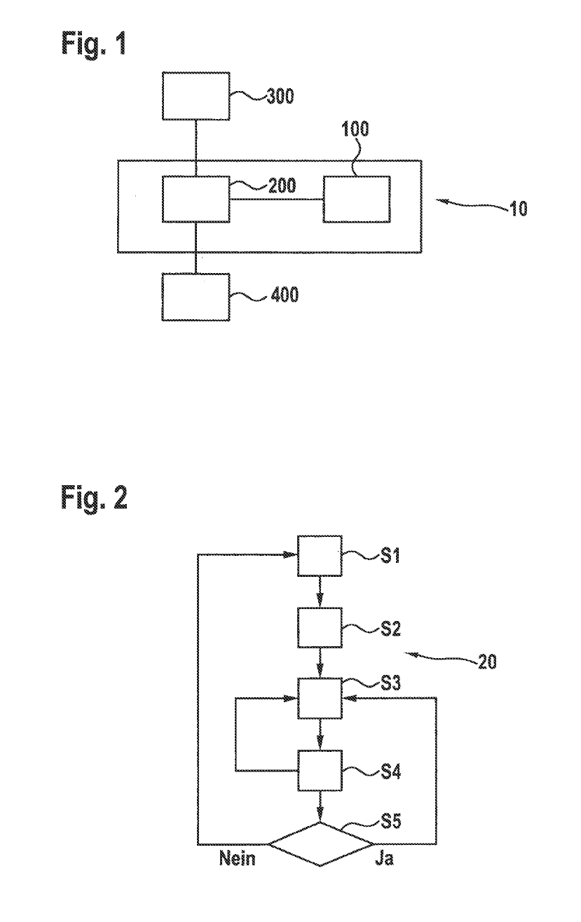

When ascertainment unit 200 executes the set of instructions, and once the driver has been identified and a driver-specific initialization or parameterization has taken place, it executes a step S1 of method 20 of the present invention of the exemplary embodiment shown in FIG. 2. Step S1 includes the readout of activity information from a mobile memory device, which is a memory of a smartphone of the driver in the exemplary embodiment. The driver's smartphone can be detected in different ways. For example, it is the only mobile memory unit that is reachable via a wireless link such as Bluetooth or WLAN (wireless local area network). Or it is the particular mobile memory device that is reachable in a wireless manner by the strongest signal link. It is also possible that the mobile memory device is detected with the aid of a wire-bound link. Another possibility is the storage of an unambiguous identification (device ID) which is linked to the stored facial features, the mobile memory device transmitting its ID to device 10 when establishing a connection. Device 10 may then compare transmitted identifications with the stored identification and thereby identify the mobile memory device from which driver-specific activity information is to be read out.

In the exemplary embodiment illustrated, a step S2 will then be executed, which includes an adaptation of the driver-specific circadian rhythm on the basis of the activity information. In the following step S3, a driver-specific change in the fatigue degree is ascertained. For example, earlier changes in the speed of vehicle 30 instituted or currently undertaken changes in the speed of vehicle 30 by the driver are used for this purpose. In the exemplary embodiment, the earlier speed changes initiated by the driver are read out from memory unit 100, and the currently initiated speed changes are recorded via the connection between ascertainment unit 200 and control unit 400. Within the sense of the present invention, changes in the absolute amount of the speed (stepping on the accelerator, releasing the accelerator, or braking), changes in the direction of the speed (steering wheel angle) and changes in the rate of the speed change, speed direction (change in the steering wheel angle) are able to be understood as speed changes.

In addition or as an alternative it is also possible to (additionally) use an exterior camera and/or an interior camera for the fatigue degree change. Especially a blinking frequency of the driver and/or a maximum eye opening of the driver may be recorded with the aid of the interior camera and utilized for the fatigue degree change. The blinking frequency of and/or a maximum eye opening can be used on their own or in combination with lane data from the exterior camera and/or speed changes of the vehicle 30.

In step S4, the fatigue degree is finally ascertained on the basis of a previous fatigue degree and the ascertained change in the fatigue degree. The previous fatigue degree depends on a driver-specific circadian rhythm and on data about the driver from a time period during which the driver is not driving vehicle 30. In the exemplary embodiment, these data include the activity information that was read out. For example, information relating to recent stays in time zones other than that in which vehicle 30 is currently traveling may be used for a jet-lag-related correction of the circadian rhythm. It is also possible to correct the circadian rhythm on the basis of a daily rhythm of the driver, which is defined by commuting routes that are regularly traveled by the driver. Because the commuting routes are determined via access to the smartphone, they are able to be considered independently of whether they were undertaken with the aid of vehicle 30. Moreover, past and/or future appointments may be used for adapting the previous fatigue degree of the driver. For example, strenuous physical exercise activities and/or protracted business appointments that have taken place shortly before a drive are able to be taken into account since they go hand in hand with an increase in the fatigue degree. In the same way, important appointments after a drive may affect the alertness and thereby lead to a more rapid increase in the fatigue degree.

The method then returns to step S3, the currently ascertained fatigue degree serving as previous fatigue degree in the renewed execution of step S4. The currently ascertained fatigue degree is stored for this purpose, for instance in memory unit 100.

When the drive has come to an end, the most recently determined fatigue degree may be stored in memory unit 200.

In one further development of the exemplary embodiment of the method of the present invention, once a driver has finished driving, device 10 monitors in a comparison step S5 whether driving is resumed by the driver within a short time interval. This means that the duration of a break during driving is ascertained, the driver having driven or driving vehicle 30 prior to and after the break in travel, and the ascertained duration is compared to a limit value. If the ascertained duration remains below the limit value, then the method will return to step S3. On the other hand, if the ascertained duration exceeds the limit value, the method returns to step S1.

Apart from steps S3 and S4, exemplary specific embodiments of the method according to the present invention also include step S5, steps S1 and S2 or the steps S1, S2 and S5.

What is claimed is:

1. A method for ascertaining a fatigue degree of a driver of a vehicle, the method comprising:
providing a driver-specific ascertainment of a change in the fatigue degree by ascertaining the fatigue degree based on a previous fatigue degree that is ascertained with the aid of a driver-related circadian rhythm and the ascertained change in the degree of fatigue;
wherein the previous fatigue degree is ascertained using data about the driver during a period in which the driver is not driving the vehicle.

2. The method of claim 1, wherein the time period lies in the past and the driver has driven or is driving the vehicle directly prior to and following the time period, the data including a length of the time period, and the length being compared to a limit value in a comparison, and if the length drops below the limit value, the previous fatigue degree is ascertained with the aid of a further fatigue degree that was determined based on a speed change behavior directly prior to the start of the time period.

3. The method of claim 2, wherein if the length exceeds the limit value, the previous fatigue degree is ascertained with the aid of the driver-related circadian rhythm.

4. The method of claim 1, wherein the data are items of activity information, stored in a mobile memory device, about an activity or multiple activities of the driver within the time period, further comprising:
reading out the activity information from the mobile memory device; and
adapting the driver-specific circadian rhythm using the activity information.

5. The method of claim 3, where the driver is currently driving the vehicle in a particular time zone and the activity information includes time zone information about at least one stay of the driver in another time zone that differs from said time zone.

6. The method of claim 3, wherein the activity information includes a history of recurring commuting routes of the driver, and the history is used for ascertaining a daily rhythm of the driver for an adaptation of the circadian rhythm.

7. A device for ascertaining a fatigue degree of a driver of a vehicle, comprising:
a memory unit;
an ascertainment unit having a set of instructions, which is executable by the ascertainment unit and which is stored in the memory unit, for ascertaining the fatigue degree of the driver of the vehicle, by performing the following:
providing a driver-specific ascertainment of a change in the fatigue degree by ascertaining the fatigue degree based on a previous fatigue degree that is ascertained with the aid of a driver-related circadian rhythm and the ascertained change in the degree of fatigue;
wherein the previous fatigue degree is ascertained using data about the driver during a period in which the driver is not driving the vehicle.

8. The device of claim 7, further comprising:
a camera for optically detecting the face of the driver, wherein the set of instructions provides that when the set of instructions is executed by the ascertainment unit, driver-specific facial features are detected and the driver is identified using additional driver-specific facial features that are stored in the memory unit, by comparing the detected facial features with the stored facial features.

9. The device of claim 8, wherein driver-specific application parameters are stored in the memory unit, which are linked to the stored facial features so that the execution of the set of instructions by the ascertainment unit is initialize-able in a driver-specific manner by the driver-specific application parameters.

10. A vehicle, comprising:
a device for ascertaining a fatigue degree of a driver of a vehicle, including:
a memory unit;
an ascertainment unit having a set of instructions, which is executable by the ascertainment unit and which is stored in the memory unit, for ascertaining the fatigue degree of the driver of the vehicle, by performing the following:
providing a driver-specific ascertainment of a change in the fatigue degree by ascertaining the fatigue degree based on a previous fatigue degree that is ascertained with the aid of a driver-related circadian rhythm and the ascertained change in the degree of fatigue;
wherein the previous fatigue degree is ascertained using data about the driver during a period in which the driver is not driving the vehicle.
